(19) United States
(12) Patent Application Publication
(10) Pub. No.: US 2008/0151105 A1
(43) Pub. Date: Jun. 26, 2008

(54) Color motion detection circuit and Y/C separation circuit

(75) Inventor: Takashi Kudou, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/984,798

(22) Filed: Nov. 21, 2007

(30) Foreign Application Priority Data
Dec. 22, 2006 (JP) 2006-345397

(51) Int. Cl. H04N 11/20

(52) U.S. Cl. 348/451; 348/E11.021

(57) ABSTRACT

A color motion detection circuit includes 2 color correlation detection circuits for detecting a correlation of chrominance signals in a plurality of lines and detecting whether there is a color correlation between the lines, a 1 frame color motion detection circuit for performing a vertical band pass filter process to chrominance signals of a plurality of consecutive lines for each signal in a current frame and a previous frame and performing a 1 frame color motion detection according to the vertical band pass filter process result, and an output circuit to output a color motion detection result according to a detection result of the 1 frame color motion detection circuit in case either of the 2 color correlation detection circuits determines as a line correlation exists.

### BACKGROUND OF THE INVENTION

1. Field of the Invention

The present invention relates to a color motion detection circuit for detecting a color motion in a video signal of a television signal and a Y/C separation circuit for separating Y/C using the color motion detection result.

2. Description of Related Art

A video signal of a television signal is a multiplex of a luminance signal (hereinafter referred to as a Y signal) and a chrominance signal (hereinafter referred to as a C signal) modulated by a color subcarrier and generally called a composite video signal. In a television receiver, a process to separate an input composite video signal into a Y signal and a C signal is indispensable. This separation process is called Y/C separation in general.

With low accuracy of this separation, color blur, rough outline and point (dot)-like noise are generated on a screen. In early stages, 1D Y/C separation for simply separating a signal by a frequency component has been used. On the other hand, 2D Y/C separation has been developed which separates Y and C by a comparison of signals of upper and lower lines using that phases are inverted for each line of a scanning line.

3D Y/C separation uses a time-axis in addition to this in order to separate a signal more accurately by comparing signals of lines at the same position of the previous and the next frames. That is, 3DY/C separation is a method to utilize signal processing in time-axis direction (frame correlativity) when separating a color video image signal into a Y signal and a C signal, in addition to spatial process using perpendicular correlativity. However, in a method using frame correlativity, incorrect Y/C separation will be performed for an image with intense movement in which images largely differ in the previous and the next frames and in scene switching. For this reason, if images differ too much in back and forth, it is often mounted as a motion adaptive 3D Y/C separation which does not perform a comparison in time-axis direction but switches to 2D Y/C separation.

In such motion adaptive 3D Y/C separation, it is possible to eliminate dot interference in which C signal leaking to Y signal and cross color interference in which Y signal leaking to C signal. However, in a motion, generation of the above interference cannot be suppressed and especially for the cross color interference, different color from original is generated. Therefore, in an attempt to solve the problem that is highly visible and remarkably reduces image quality, the 3D Y/C separation circuit is disclosed in Japanese Unexamined Patent Application Publication No. 9-327038 (Yoshida et al).

The motion adaptive 3D Y/C separation circuit disclosed by Yoshida et al. separates a composite video signal into a luminance signal and a chrominance signal according to the amount of motion in an image. This motion adaptive 3D Y/C separation circuit includes a first chrominance signal extraction means, a second chrominance signal extraction means, a first motion detecting means, a second motion detecting means, a mixing means, an inter-frame sum extraction means, an edge detection means, a selecting means and a first maximum value means. The first chrominance signal extraction means extracts a first chrominance signal from a composite video signal by a process in 1 field. The second chrominance signal extraction means extracts a second chrominance signal from a composite video signal by a process between 1 frame. The first motion detecting means detects the amount of motion in an image by a difference component of a composite video signal between 1 frame and extracts a first motion detection signal. The second motion detecting means detects the amount of motion in an image by a difference component of a composite video signal between 2 frames and extracts a second motion detection signal. The mixing means mixes the first chrominance signal and the second chrominance signal. The inter-frame sum extraction means extracts a sum signal between 1 frame from the composite video signal. The edge detection means detects a horizontal edge component from an inter-frame sum signal and generates an edge detection signal of whether it is larger than a first predetermined value. The selecting means is input with the second motion detection signal and a second predetermined value and selects the second predetermined value if the edge detection signal indicates to be larger than the first predetermined value and selects the second motion detection signal in other cases. The first maximum value means outputs a signal of a higher level among the output of the selecting means and the first motion detection signal. Then, mixed operation of the mixing means is controlled by the output of the first maximum value means. This configuration reduces cross color interference without deteriorating motion detection performance.

Moreover, in a motion adaptive type Y/C separation, a motion detection circuit for determining to switch between motion and still image plays an important role. Being unable to perform this motion detection accurately and process a motion as a motion and a still image as a still image causes to disable an ideal Y/C separation and brings negative influences to images such as cross color and dot interference. Accordingly, a motion detection circuit for detecting a motion by combining a motion signal detected from 2 frame difference, a 2 frame difference motion signal delayed for 1 frame and a motion signal detected by 1 frame difference is disclosed in Japanese Unexamined Patent Application Publication No. 11-146417 (Sawachika).

The motion detection circuit disclosed by Sawachika includes a first frame memory, a second frame memory, a 1 frame difference motion detection circuit, a second frame difference motion detection circuit, a third frame memory and a motion signal combining circuit. The first frame memory delays an input digital video signal for 1 frame and outputs the 1 frame delayed signal to the second frame memory and the 1 frame difference motion detection circuit. The second frame memory further delays the 1 frame delayed video signal for 1 frame and outputs the 2 frame delayed signal to the 2 frame difference motion detection circuit. The 1 frame difference motion detection circuit detects a 1 frame difference motion signal from the input digital video signal and the 1 frame delayed video signal and outputs to the motion signal combining circuit. The 2 frame difference motion detection circuit detects a motion signal from the input digital video signal and the 2 frame delayed video signal and outputs a comparison signal to the third frame memory and the motion signal combining circuit. The third frame memory delays an output signal from the 2 frame difference motion detection circuit for 1 frame and outputs the signal delayed for 1 frame to the motion signal combining circuit. The motion signal combining circuit inputs the output signal from the 1 frame difference motion detection circuit, the output signal from the 2 frame difference motion detection circuit and the output signal from the third frame memory to calculate and outputs a motion signal. This configuration suppresses unnecessary motions even for a signal in which an object moves at high speed or when a pattern having diagonal lines is input.

Furthermore, Japanese Patent No. 3480477 (Miyazaki et al.) discloses a motion detection circuit attempting to suppress from generating cross color and dot interference in a still image even for a still image including fine vertical lines and diagonal lines by enabling to detect a motion correctly.

FIG. 17 shows a motion detection circuit disclosed by Miyazaki et al. As shown in FIG. 17, in the motion detection circuit disclosed by Miyazaki et al., line memories 541 and 542 delay a signal for 1H (horizontal scanning period) and output it. A frame buffer 557 stores signals for 523 lines and is made to output after 523H. Band pass filters (BPF) 543, 544 and 545 separate a chrominance signal from an input signal and output it. Inverting circuits 546 and 547 invert the polarity of the signal input respectively from the BPF 543 and 545 and output it. An adder 548 calculates a difference of a signal from the inverting circuit 546 and a signal from the BPF 544 and outputs it. An adder 549 calculates a difference of a signal from the inverting circuit 547 and a signal from the BPF 544 and output it. ABSs (absolute value computing unit) 550 and 551 calculate absolute values of the signals input respectively from the adders 548 and 549 and output them.

Comparators 552 and 553 compare the signals input respectively from the ABSs 550 and 551 with a predetermined threshold value cr1 and output a predetermined signal corresponding to the comparison result. An OR circuit 554 calculates logical sum of the signals from the comparators 552 and 553 and outputs the result. A switch 555 switches internal connection in response to the signal from the OR circuit 554 and outputs a signal from the BPF 544 or a signal of 0 level. An ABS 556 is made to calculate an absolute value of the signal from the switch 555 and output it.

Moreover, for a signal passed through the frame buffer 557, line memories 561 and 562, an inverting circuit 566, BPFs 563, 564 and 565, adders 568 and 569, ABSs 570 and 571, comparators 572 and 573, an OR circuit 574, a switch 575 and a ABS 576 are formed in a similar way.

ABSs 581 and 582 calculate absolute values of signals supplied from the BPFs 544 and 564. An adder 583 calculates a difference of these signals and outputs it. A comparator 584 compares the signal supplied from the adder 583 with a predetermined threshold cr2 and outputs a signal corresponding to the comparison result.

An adder 585 calculates a difference of a signal supplied from the ABS 556 and a signal supplied from the ABS 576 and outputs it. An ABS 586 calculates an absolute value of a signal supplied from the adder 585 and outputs it. An AND circuit 587 calculates logical AND of the signal supplied from the ABS 586 and the signal supplied from the comparator 584 and outputs it. A multiplier 588 adjusts a gain of the signal input from the AND circuit 587. A limiter 589 reduces the number of bits of the signal input from the multiplier 588 to the predetermined number of bits.

In this motion detection circuit, the horizontal BPFs 543 to 545 and 563 to 565 extract C signals of each line for each signal of the current frame and the previous frame. Similarly, for a signal after a horizontal BPF signal, the adders 548, 549, 568 and 569 detect a correlation between the target line and the previous line in which color signals are inverted phase and a correlation between the target line and the next line in which color signals are inverted phase. Then, the comparators 552, 553, 572 and 573 compare the output values with the reference level. The OR circuit 554 and the switch 555 take OR logic of the 2 comparison results and enables an output of the 1 frame color motion detection circuits if there is a color correlation in either of the lines or outputs “0” in other cases.

Moreover, by the horizontal BPFs 544 and 564, for each of the signals in the current frame and the next frame, a C signal of the current line is extracted. The ABSs 581 and 582 convert the output result of the horizontal BPFs 544 and 564 into absolute values. A difference circuit 583 takes a difference of the output of the ABSs 581 and 582 of the current and previous frames. The comparator 584 compares an external setting value with the output of the difference circuit 583. If this chroma level difference is below the external setting value, the output result of the 1 frame color motion detection circuit is “0”.

However, the motion adaptive 3D Y/C separation circuit disclosed by Yoshida et al. uses the inter-frame sum signal only for edge detection and also the edge detection is used only for gain adjustment of 2 frame difference signal motion. Furthermore, extraction of a C signal by BPF process is not performed and line correlativity for color signal is also not used. Therefore, although 1 frame motion detection and motion detection between 2 frames are used complementarily, as the 1 frame motion detection is performed after a LPF process, the chrominance signal component is removed. For this reason, since 1 frame color motion detection is not performed for a chrominance signal component, a motion may not be correctly detected.

Moreover, as for the technique disclosed by Sawachika, although the inter-frame difference motion detection circuit is mounted, only a chrominance signal between lines is extracted and horizontal BPF process for band limitation is not provided. Moreover, detection of correlation between lines is not performed. Therefore, as a simple chrominance signal extraction is performed without band limitation in horizontal direction by a sum between lines, many luminance components other than the chrominance signal leak and it is highly possible to incorrectly detect something other than chrominance signal. Moreover, if luminance components leak, in the method of not detecting correlation between lines as in Sawachika, it is difficult to detect 1 frame color motion correctly. That is, in the case luminance components without correlation between frames and lines incorrectly leak, as 1 frame color motion detection for performing an addition process between lines adds the same signal, it is always determined as a motion.

Furthermore, as the technique disclosed by Miyazaki et al. converts into an absolute value after a BPF process to perform a difference process between frames, for those with chrominance signals being inverted phase between frames, a motion can be extracted by adding the chrominance signals. However, as the chrominance signals are converted into absolute values to perform a difference calculation, there is a problem that a motion cannot be extracted. In the 1 frame color motion detection circuit disclosed by Miyazaki et al, a color motion can be correctly detected for chrominance signals with different amplitudes. However, as the color motion detection is determined by the difference in the absolute values, a motion of inverted phase signal with same absolute value cannot be detected. Therefore, I have now discovered that there is a problem that a motion cannot be correctly detected when a chrominance signal of inverted phase with same amplitude is input.

### SUMMARY

In one embodiment, a color motion detection circuit includes a color correlation detection circuit to detect a correlation of chrominance signals in a plurality of lines and detect whether there is a color correlation between the lines, a 1 frame color motion detection circuit to perform a vertical band pass filter process to chrominance signals of a plurality of consecutive lines for each signal in a current frame and a previous frame and perform a 1 frame color motion detection according to the vertical band pass filter process result and an output circuit to output a color motion detection result according to a detection result of the 1 frame color motion detection circuit in case the color correlation detection circuit determines as a line correlation exists.

In the present invention, a line correlation is detected by the color correlation detection circuit. If a line correlation exists, the color motion detection result is output according to the 1 frame motion detection result in which a motion is detected from a signal obtained by performing a vertical band pass filter process to a chrominance signal. Therefore, even if chrominance signals with the same amplitude and inverted phase are input, a color motion can be correctly detected.

In another embodiment, a Y/C separation circuit includes a color motion detection circuit to output a color motion detection result, a coefficient mix circuit to generate a chrominance signal by mixing a chrominance signal within frame and a chrominance signal between frames according to a luminance motion detection result and the color motion detection result, where the chrominance signal within frame is a chrominance signal extracted using signals in a same frame and the chrominance signal between frames is a chrominance signal extracted using signals between adjacent frames and a subtractor to subtract the chrominance signal from a composite signal and output a luminance signal. The color motion detection circuit includes a color correlation detection circuit to detect a correlation of chrominance signals in a plurality of lines and detect whether there is a color correlation between the lines, a 1 frame color motion detection circuit to perform a vertical band pass filter process to chrominance signals of a plurality of consecutive lines for each signal in a current frame and a previous frame and perform a 1 frame color motion detection according to the vertical band pass filter process result and an output circuit to output a color motion detection result according to a detection result of the 1 frame color motion detection circuit in case the color correlation detection circuit determines as a line correlation exists.

In another embodiment, a Y/C separation circuit includes a first coefficient mix circuit to generate a chrominance signal by mixing a chrominance signal within frame and a chrominance signal between frames according to a luminance motion detection result and a motion detection result between 2 frames, where the chrominance signal within frame is a chrominance signal extracted using signals in a same frame and the chrominance signal between frames is a chrominance signal extracted using signals between adjacent frames, a subtractor to subtract a chrominance signal generated by the first coefficient mix circuit from a composite signal and output a luminance signal, a color motion detection circuit to output a color motion detection result and a second coefficient mix circuit to mix the chrominance signal within frame and the chrominance signal between frames according to the color motion detection result and generate a chrominance signal. The color motion detection circuit includes a color correlation detection circuit to detect a correlation of chrominance signals in a plurality of lines and detect whether there is a color correlation between the lines, a 1 frame color motion detection circuit to perform a vertical band pass filter process to chrominance signals of a plurality of consecutive lines for each signal in a current frame and a previous frame and perform a 1 frame color motion detection according to the vertical band pass filter process result and an output circuit to output a color motion detection result according to a detection result of the 1 frame color motion detection circuit in case the color correlation detection circuit determines as a line correlation exists.

In the present invention, based on the result of the color correlation detection circuit, as a Y/C separation is performed using an accurate color motion detection result obtained according to the 1 frame motion detection result by performing a vertical band pass filter, a Y/C separation can be accurately performed. That is, the present invention is able to provide a color motion detection circuit with improved color motion detection accuracy and a Y/C separation circuit mounted therewith.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing a color motion detection circuit according to a first embodiment of the present invention;

FIG. 2 shows a Y/C separation circuit according to the first embodiment of the present invention;

FIG. 3 shows a relationship of phases of C signals;

FIG. 4 shows signal waveforms of each node A to H and A′ to F′ of the color motion detection circuit shown in FIG. 1 according to the first embodiment of the present invention;

FIG. 5 similarly shows signal waveforms of each node A to H and A′ to F′ of the color motion detection circuit shown in FIG. 1 according to the first embodiment of the present invention;

FIG. 6 similarly shows signal waveforms of each node A to H and A′ to F′ of the color motion detection circuit shown in FIG. 1 according to the first embodiment of the present invention;

FIG. 7 similarly shows signal waveforms of each node A to H and A′ to F of the color motion detection circuit′ shown in FIG. 1 according to the first embodiment of the present invention;

FIG. 8 shows signal waveforms of each node A to H and A′ to F′ of a color motion detection circuit shown in FIG. 17 disclosed by Miyazaki et al.;

FIG. 9 similarly shows signal waveforms of each node A to H and A′ to F′ of the color motion detection circuit shown in FIG. 17 disclosed by Miyazaki et al.;

FIG. 10 similarly shows signal waveforms of each node A to H and A′ to F′ of the color motion detection circuit shown in FIG. 17 disclosed by Miyazaki et al.;

FIG. 11 similarly shows signal waveforms of each node A to H and A′ to F′ of the color motion detection circuit shown in FIG. 17 disclosed by Miyazaki et al.;

FIG. 12 is a block diagram showing a color motion detection circuit according to a second embodiment of the present invention;

FIG. 13 shows a Y/C separation circuit according to the second embodiment of the present invention;

FIG. 14 explains effects by the second embodiment of the present invention;

FIG. 15 is a block diagram showing a color motion detection circuit according to a third embodiment of the present invention;

FIGS. 16A and 16B explain effects by the third embodiment of the present invention; and

FIG. 17 is a motion detection circuit disclosed by Miyazaki et al.

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

Hereafter, detailed embodiment incorporating the present invention is described in detail with reference to the drawings. This embodiment incorporates the present invention to a color motion detection circuit having a color correlation detection circuit for detecting a color correlation between lines in which color phases in a frame are inverted phases so as to enable 1 frame color motion detection only when detecting a color correlation, in a color motion detection circuit of 3D Y/C separation.

In this embodiment, by a BPF process (vertical BPF) performed to a plurality of lines in vertical direction, a difference in phases and amplitudes between frames is detected. Performing an addition process between frames after a vertical BPF process enables to see phase difference information between frames and accurately detect a motion.

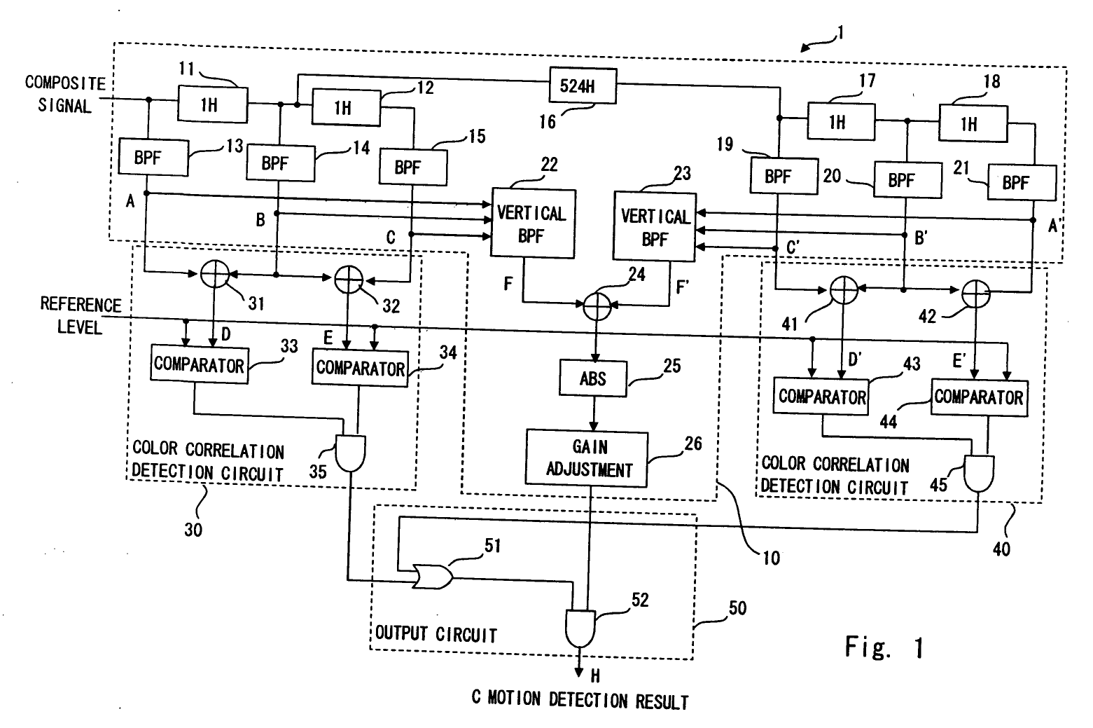

FIG. 1 is a block diagram showing a color motion detection circuit according to this embodiment. A color motion detection circuit 1 according to this embodiment includes color correlation detection circuits 30 and 40, a 1 frame color motion detection circuit 10 and an output circuit 50. The color correlation detection circuits 30 and 40 detect a correlation of C signals in the target line and the previous line and if there is a color correlation in both sides of the target line, detect as “line correlation exists”. For each signal of the current frame and the previous frame, the 1 frame color motion detection circuit 10 performs a vertical BPF process to C signals for the consecutive 3 lines and detects 1 frame color motion according to the vertical BPF process result. If the color correlation detection circuits 30 and 40 detect as “line correlation exists”, the output circuit 50 outputs a color motion detection result according to the detection result of the 1 frame color motion detection circuit 10.

The 1 frame color motion detection circuit 10 includes line memories 11, 12, 17 and 18, BPFs 13 to 15 and 19 to 21, vertical BPFs 22 and 23, an adder 24, an ABS 25 and a gain adjustment circuit 26. The color correlation detection circuit 30 includes adders 31 and 32, comparators 33 and 34 and an AND circuit 35. The color correlation detection circuit 40 includes adders 41 and 42, comparators 43 and 44 and an AND circuit 45. The output circuit 50 includes an OR circuit 51 and an AND circuit 52.

Firstly, the 1 frame color motion detection circuit 10 is explained. The line memories 11, 12, 17 and 18 delay a signal for only 1 horizontal scanning period and output it. A 524H delay circuit 16 stores signals for 524 lines and is made to output after 524H. The BPFs 13 to 15 and 19 to 21 are horizontal BPFs for extracting C signals of the consecutive 3 lines for each signal of the current frame and the previous frame. That is, each output of the BPFs 13 to 15 and 19 to 21 is an extraction of a C signal from a composite signal.

The vertical BPFs 22 and 23 perform a vertical BPF process to output 3 lines after the BPF process, the BPFs 13 to 15 and 19 to 21. The vertical BPF process carries out the following processes with a line in vertical direction.

{(C signal of the current line)×2−(C signal of the previous line)−(C signal of the next line)}/4

This vertical BPF process uses that the color phase of the present line and the color phases of the previous and the next lines are inverted phases. If a signal of the present line and a signal of the previous and the next lines are the same color, the signal after the vertical BPF process indicates a phase and an amplitude of a C signal. In this embodiment, a phase and an amplitude of a C signal are used for color motion detection and the vertical BPF process is provided in order to determine a signal as a motion, which was not able to be determined as a motion in related arts.

The adder 24 adds the signals after the vertical BPF process in the current frame and the previous frame. Since the phases are inverted in the previous and the next frames, the addition result will be 0 if there is no motion. The ABS 25 converts this result into an absolute value and the gain adjustment circuit 26 adjusts the gain of the absolute value. Adjusting the gain of the value of the ABS 25 generates a multi-bit signal indicating how much motions there are. The result of the gain adjustment circuit 26 is 1 frame color motion detection result and this result is enabled or disabled by the output circuit 50 described later.

Next, the color correlation detection circuits 30 and 40 are explained. In the color correlation detection circuit 30, for a signal after the horizontal BPF process, the adders 31 and 32 detect a correlation of the target line and the previous line in which C signals are inverted phase and similarly, a correlation of the target line and the next line in which C signals are inverted phase. That is, if “line correlation exists”, for example the same color, the addition result is 0. The comparators 33 and 34 detect whether there is any correlation between lines by comparing the output values of the adders 31 and 32 with the reference level. Accordingly, the comparators 33 and 34 output “1” as “line correlation exists”, if the output values of the adders 31 and 32 are below the reference level. The AND circuit obtains an AND logic of the 2 level comparison results and enables the outputs (line correlation exists) only when there is a color correlation in both side of the lines. The color correlation detection circuit 40 operates in the same way.

Next, the output circuit 50 is explained. The color correlation detection circuits 30 and 40 are accomplished by addition of signals of consecutive 2 lines and evaluate both signals of the current line and the previous line and signals of the current line and the next line. When the color correlation result of the current frame by the color correlation detection circuit 30 or the color correlation result of the previous frame by the color correlation detection circuit 40 is determined to be “line correlation exists”, the OR circuit 51 of the output circuit 50 outputs the determination result that enables the abovementioned 1 frame color motion detection result. That is, the output of the OR circuit 51 and the output of the gain adjustment circuit 26 which is the 1 frame color motion detection result are input to the AND circuit 52 and only when the output from the OR circuit 51 is enabled (line correlation exists), the 1 frame color motion detection result is output.

As a phase and an amplitude of a C signal are detected by a vertical BPF process, this embodiment enables a color motion detection between frames. This enables a motion detection even in a case when there is a line correlation and C signals are inverted phase between frames, which was not detected in related arts.

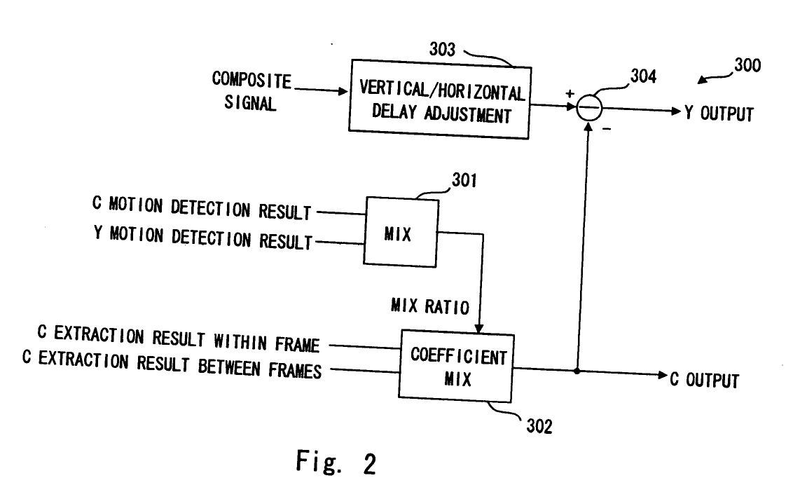

Next, the Y/C separation circuit using this color motion detection result is explained. FIG. 2 shows the Y/C separation circuit according to this embodiment. The motion detection result detected in the color motion detection circuit shown in FIG. 1 is input to the C motion detection result.

A Y motion detection result is obtained by performing a horizontal LPF process to an inter-frame difference, for example. Moreover, a C extraction result within frame can be generated by performing a filtering process between lines and in horizontal direction within the same frame. Generally it can be generated by a 2D Y/C separation circuit. Or it may be generated by a comb filter inside frame. The C extraction result between frames can be obtained by difference between frames×½.

A Y/C separation circuit 300 includes a MIX unit 301, a coefficient MIX unit 302, a vertical/horizontal delay adjusting unit 303 and a subtractor 304. The MIX unit 301 is input with the C motion detection result output from the C motion detection circuit according to this embodiment shown in FIG. 1 and the Y motion detection result and takes the maximum value. The coefficient MIX unit 302 multiplies a maximum value k selected by the MIX circuit 301 by the C extraction result within frame, for example, and multiplies the C extraction result between frames by (1−k) to generate a C signal. The subtractor 304 subtracts the C signal generated in the coefficient MIX unit 302 from the signal performed with a horizontal/vertical delay adjustment in the composite signal vertical/horizontal delay adjusting unit 303 to generate a Y signal.

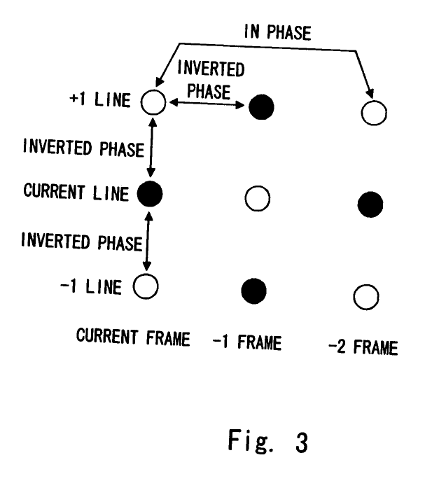

Next, the operation of the color motion detection circuit according to this embodiment is explained along with the operation of the color motion detection circuit disclosed by Miyazaki et al. Firstly, the relationship of a phase of a C signal included in a composite signal is explained. FIG. 3 shows the relationship of the phases of C signals. A C signal modulates a reference signal called a color subcarrier to be multiplexed with a luminance signal. In the case of the NTSC (National Television System Committee) format, the carrier frequency is selected so that the phase of a color subcarrier may be inverted for every frame and every line. Accordingly, as shown in FIG. 3, the current line and both adjacent lines are inverted phase. Moreover, signals of the current frame and the previous are inverted phases. On the other hand, signals of the current frame and 2 frames before are in phase.

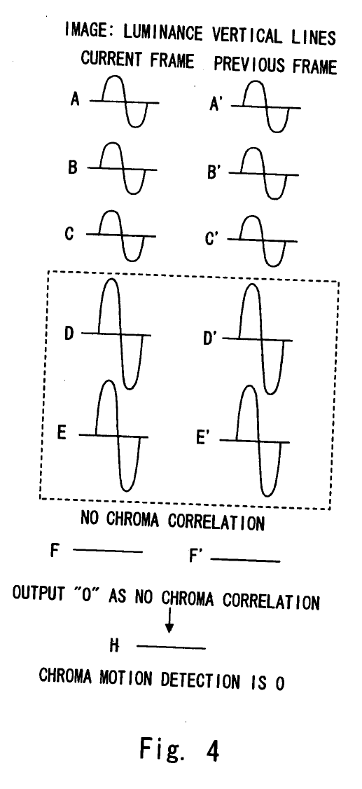

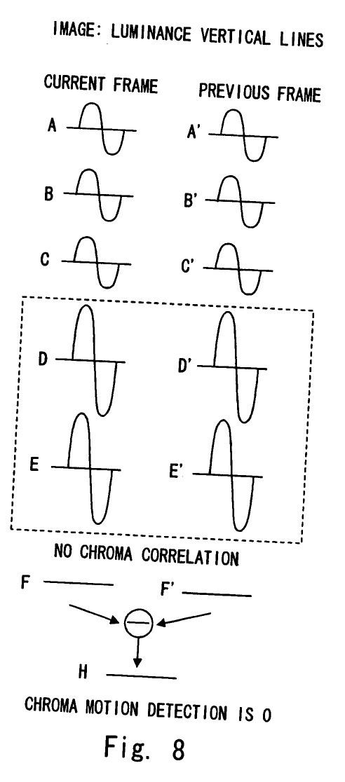

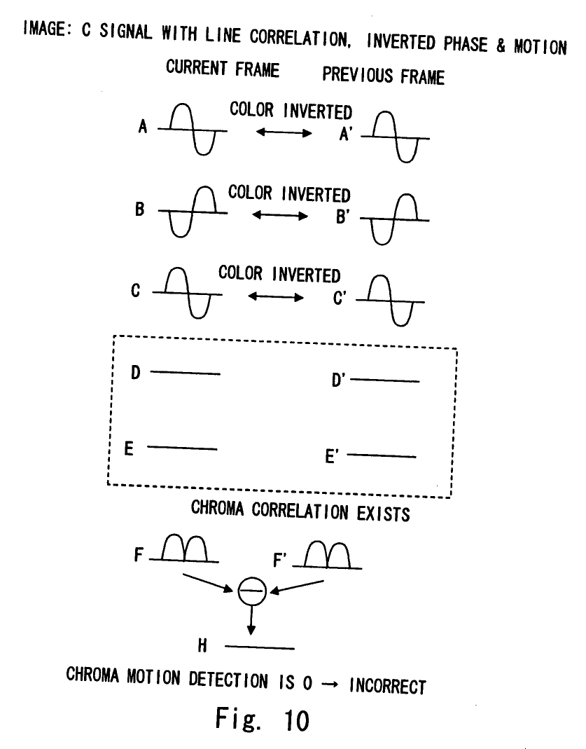

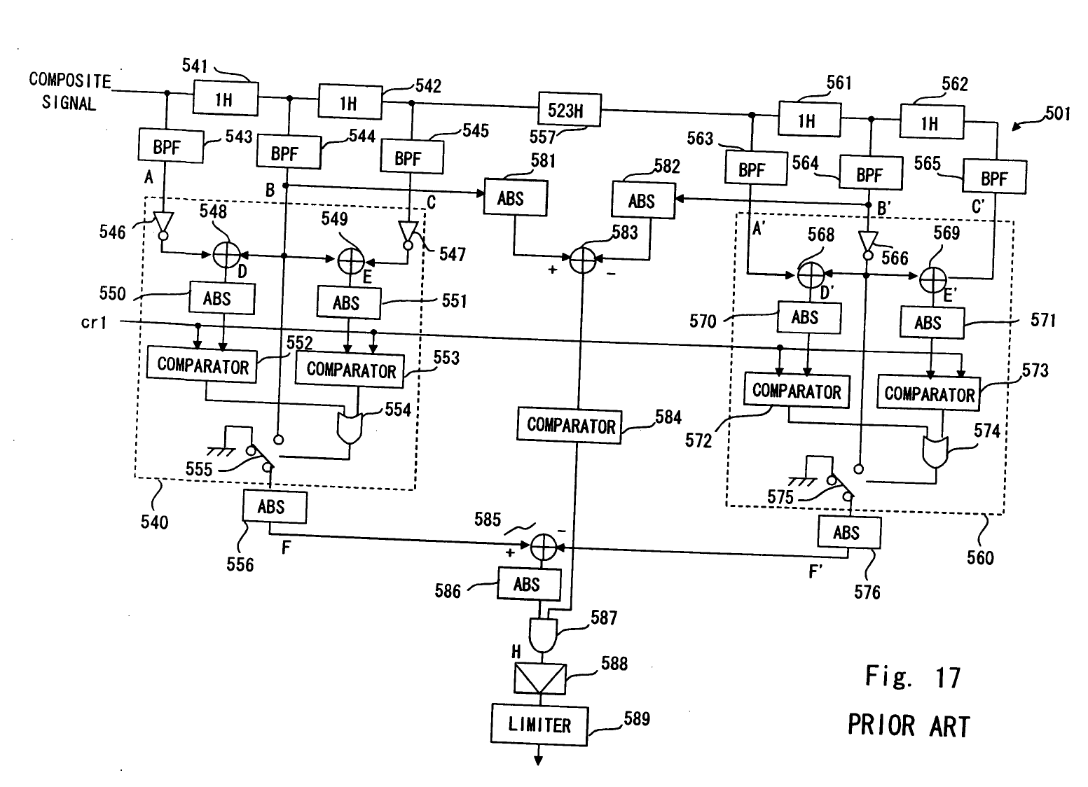

FIGS. 4 to 7 show signal waveforms of each node A to H and A′ to F′ of the color motion detection circuit shown in FIG. 1 according to this embodiment of the present invention. FIGS. 8 to 11 show signal waveforms of each node A to H and A′ to F′ of the color motion detection circuit shown in FIG. 17 disclosed by Miyazaki et al.

As shown in FIG. 4, the nodes A to C and A′ to C′ respectively show output waveforms of the BPF 13 to 15 and 19 to 21. In the example shown in FIG. 4, the waveforms taken out show the case where signals are in phase for the current frame and the previous frame and also between lines in a frame. Such an image is for example an image with vertical lines of luminance. The waveforms of the nodes D and E, D′ and E′ respectively indicate A+B, B+C, A′+B′ and B′+C′, showing the output waveforms of the adders 31, 32, 41 and 42. In this example, as all the waveforms are in phase, the amplitudes are doubled. These signals are determined to be more than the reference level as compared with the reference level and no chroma correlation. Then “0” is output from the AND circuits 35 and 45. Therefore, the output of the AND circuit 52 is “0”, meaning that 1 frame color motion detection result is invalid. Also in the color detection circuit disclosed by Miyazaki et al., it is determined as no color motion as shown in FIG. 8.

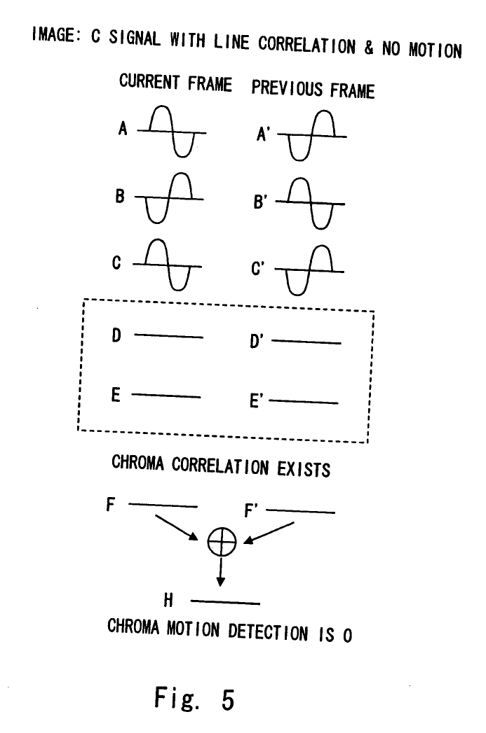

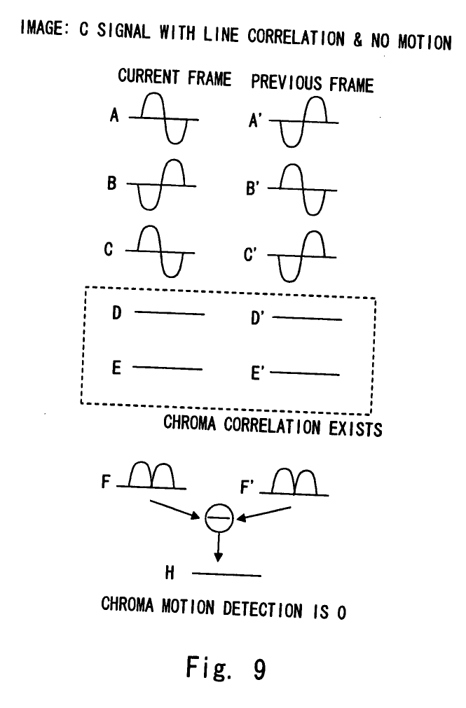

On the other hand, as shown in FIG. 5, the case where there is no motion in a C signal having correlation between lines is considered. The phases are inverted for the signals of the nodes A to C, indicating the same color. If the phases are inverted for A and A′, B and B′ and C and C′, indicating the same color, as shown in D, E, D′ and E′, as it is the same color between lines, a sum signal is 0, which is smaller than the reference level. Thus it is determined as “line correlation exists”. Therefore, the 1 frame color motion detection result output from the gain adjustment circuit 26 is enabled and output. Here, since the outputs of the vertical BPFs 22 and 23 are the same color, the signals have phases inverted to each other and the output from the adder 24 is “0”. Therefore, the C motion detection result is 0. Moreover, also in the color detection circuit disclosed by Miyazaki et al., as shown in FIG. 9, a difference signal of the ABSs 581 and 582 is 0 and is determined as no color motion.

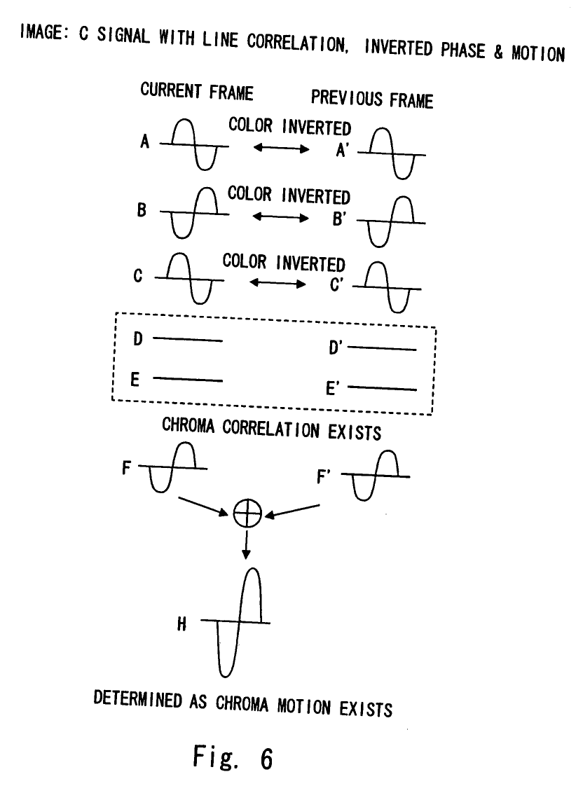

Furthermore, the example shown in FIG. 6 shows the case where C signals with line correlation are inverted phase and there are motions. That is, as the current frame and the previous are the same color and the same phase between frames, it is the case when a phase has changed to an opposite color. Also in this case, as shown in D, E, D′ and E′, it is the same color between lines and a sum signal is 0, which is smaller than the reference level. Thus the color correlation detection circuits 30 and 40 determine as “line correlation exists” and enables the 1 frame color motion detection result. Since the output F of the vertical BPFs 22 and 23 is in-phase respectively, they are superimposed by the adder 24 and the 1 frame color motion detection result is output with a color motion exist.

Here, after extracting a C signal, the color motion detection circuit disclosed by Miyazaki et al. calculates absolute values by the ABSs 556 and 576 and then subtracts, thus a difference signal is 0 meaning that it is determined as no motion. That is, as in this example, for the color with the same amplitude and inverted phase, it is incorrectly determined as no motion.

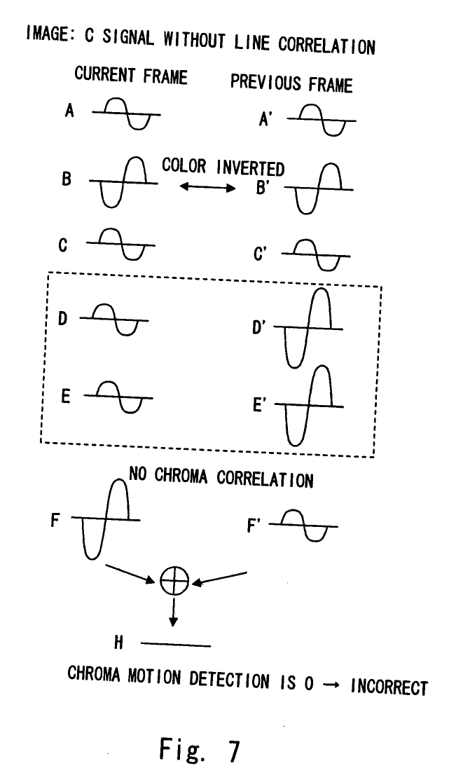

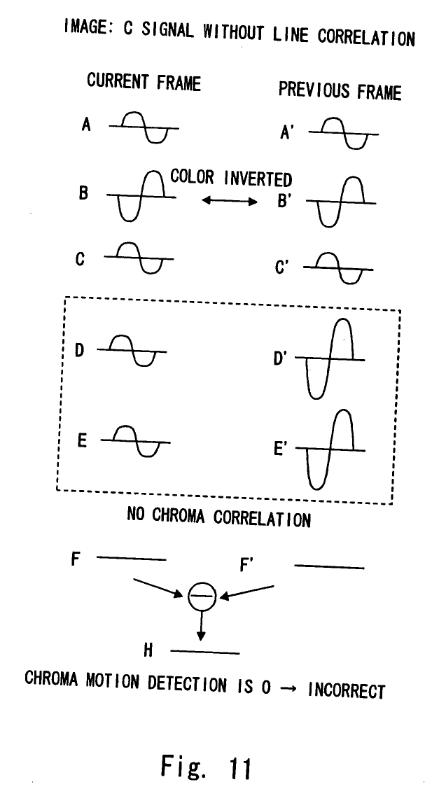

Note that as shown in FIGS. 7 and 11, in the case of a C signal with no line correlation, even if there is a motion, it is incorrectly detected as no motion by any color motion detection circuit.

In this embodiment, since the 1 frame color motion detection circuit performs a horizontal BPF and a vertical BPF process to a composite signal and adds between frames after extracting a C signal component, it is possible to accurately detect a color motion between 1 frame. Moreover, by mixing the color motion detection result with a luminance motion detection result separately calculated, by calculating a mix ratio of the C extraction result within frame and the C extraction result between frames, outputting a C component according to the result and subtracting the C component from a signal, which is a composite signal input performed with a horizontal/vertical delay adjustment, a Y/C separation circuit can be achieved which outputs a Y component.

### Second Embodiment

Next, the second embodiment of the present invention is explained. In this embodiment, in a color motion detection of 3D Y/C separation, a color correlation between lines is detected where color phases within a frame are inverted phase. Only when there is a color correlation, 1 frame color motion detection for detecting an amplitude/phase motion of carrier component is enabled. When there is no color correlation between lines, a color motion is detected by a difference signal between 2 frames. Accordingly, incorrect detection in case there is no abovementioned correlation between lines can be reduced.

In the technique disclosed by Miyazaki et al., as the determination condition for color motion detection is limited to the case having a correlation between lines, a color motion cannot be detected for an image with no color correlation between lines. Thus for a motion of a C signal which cannot be determined by a luminance motion detection, it is determined as still. Meanwhile, in addition to the abovementioned color correlation detection circuit and the 1 frame color motion detection circuit, a motion detection circuit between 2 frames for calculating by a difference of composite signals is provided. When the color correlation detection circuit determined as “correlation exists”, maximum values of the 1 frame color motion detection circuit and the motion detection result between 2 frames are enabled and when determined as “no correlation”, the result of the motion detection circuit between 2 frames is enabled. Accordingly, a motion can be correctly detected for those with no color correlation between lines.

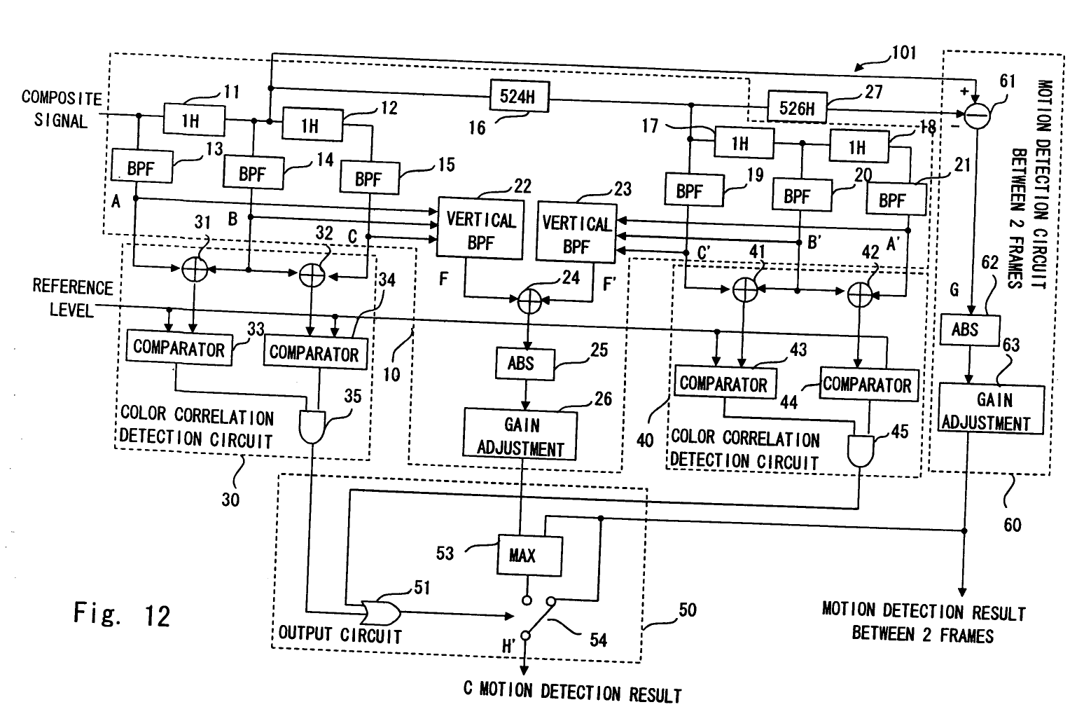

FIG. 12 is a block diagram showing a color motion detection circuit according to this embodiment. Note that in the second embodiment shown in FIG. 12, components identical to those in the first embodiment shown in FIG. 1 are denoted by reference numerals identical to those therein with detailed description omitted. A color motion detection circuit 101 according to this embodiment further includes a motion detection circuit between 2 frames 60 in addition to the color motion detection circuit 1 shown in FIG. 1. Furthermore, in the output circuit 50, a MAX circuit which takes an output of the 1 frame color motion detection circuit 10 and a MAX of the output of the motion detection circuit between 2 frames 60 is provided.

That is, the motion detection circuit between 2 frames 60 includes a difference circuit 61 which takes a difference between a signal, which is an input composite signal delayed for 1H and then 2 frames, and a signal, which is an input composite signal of the current frame delayed for 1H, an absolute value conversion circuit (ABS) 62 and a gain adjustment circuit 63. In order to delay for 2 frames, a 526H delay circuit 27 is provided in addition to the 524H delay circuit 16.

The output circuit 50 includes an OR circuit 51 input with the result of the color correlation detection circuits 30 and 40, a maximum value circuit MAX 53 and a switch 54. The maximum value circuit MAX 53 takes the result of the 1 frame color motion detection circuit 10 and the maximum value of the motion detection circuit between 2 frames 60. If either of the color correlation detection results for the current frame or the previous frame is determined as “line correlation exists”, the maximum value circuit MAX 53 outputs the maximum value. The switch 54 selects the results of the motion detection circuit between 2 frames 60 if there is no line correlation and if “line correlation exists”, selects the output of the maximum value circuit MAX 53. This switch 54 is controlled by the output of the OR circuit 51 and switches to output the result of the MAX 53 and the motion detection circuit 60 between 2 frames.

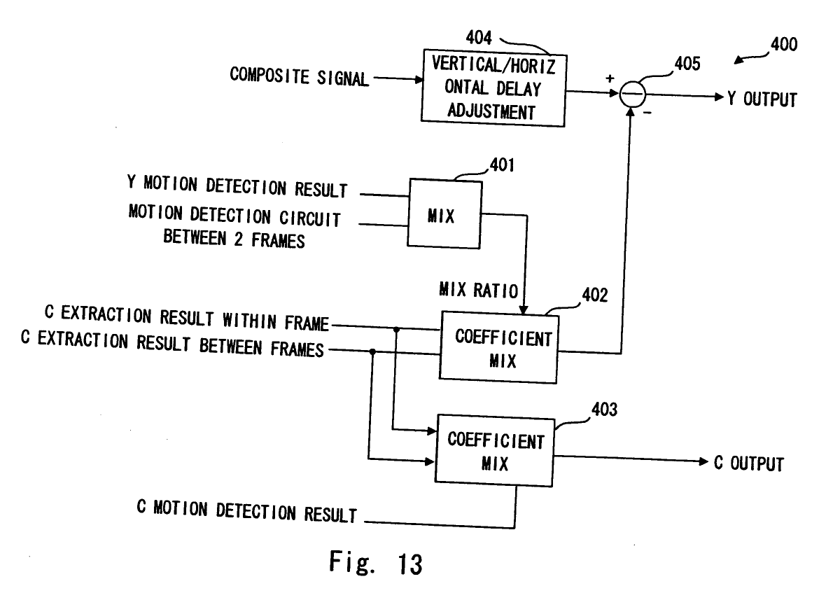

As with the first embodiment, the C motion detection circuit formed in this way can be input into the Y/C separation circuit shown in FIG. 2 and used for Y/C separation. Moreover, FIG. 13 shows another example of a Y/C separation circuit. A Y/C separation circuit 400 includes a MIX circuit 401, coefficient MIX circuits 402 and 403, a horizontal/vertical delay adjustment unit 404 and a subtractor 405. A Y motion detection result and a motion detection result between 2 frames are input to the MIX circuit 401 and the maximum value is output as a coefficient k1. The C extraction result within frame, the C extraction result between frames and the coefficient k1 are input to the coefficient MIX circuit 402. For example the C extraction result within frame is multiplied by the coefficient k1, the C extraction result between frames is multiplied by (1−k) and they are added to generate a C signal for generating a Y signal. A Y signal can be obtained by subtracting an output of the coefficient MIX circuit 402 from a signal, which is a composite signal performed with a horizontal/vertical delay adjustment by the horizontal/vertical delay adjustment unit 404, using the subtractor 405. Moreover, a C motion detection result k2 of the C motion detection circuit 101 in FIG. 12, the C extraction result within frame and the C extraction result between frames are input to the coefficient MIX circuit 403. Then for example the C extraction result within frame is multiplied by k2, the C extraction result between frames is multiplied by (1−k2) and they are added to generate a C signal.

In this embodiment, as it is possible to appropriately switch between 1 frame color motion detection and motion detection between 2 frames according to the line correlation result, a color motion can be detected for those without line correlation. That is, a vertical BPF process enables a color motion detection between frames. This suppresses from generating dots due to incorrect Y/C separation caused by a generation of motion non-detected area when the motion detection between 2 frames is determined as still and only the color component varied between frames. Moreover, by combining the motion detection between 2 frames, a motion can be correctly detected for those without color correlation between lines.

Furthermore, by mixing the color motion detection result with the luminance motion detection result separately calculated, a Y/C separation can be performed by calculating the mix ratio between the C extraction result within frame and C extraction result between frames, subtracting a C component from a composite signal input so as to output a Y component, mixing the C extraction result within frame with the C extraction result between frames according to the C motion detection result generated in this embodiment separately from this output and outputting a C component.

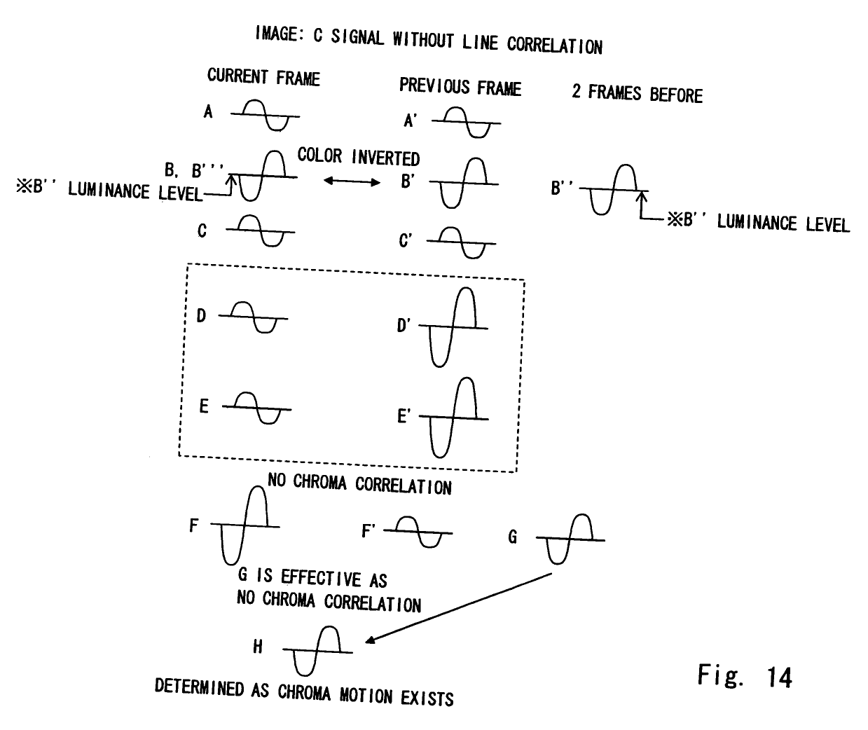

Next, the effect obtained in this embodiment is explained. FIG. 14 shows a C signal in case there is no correlation between lines which is incorrectly detected in the first embodiment. Note that for the waveforms of the nodes B′″, and B″, a luminance signal is included as they are composite signals. Here, for ease of explanation, B and B′″ are shown as waveforms of the same luminance level. However in fact, the luminance level of the signal of the node B is 0 and, the signal of the node B′″ has a certain luminance level. Moreover, a certain luminance level shall be included also for the node B″. In this example, as mentioned above, as there is no color correlation, the switch 54 in the output circuit 50 selects an output G of the motion detection circuit between 2 frames 60. Accordingly, this enables a motion detection in case there is no correlation between lines which cannot be detected in the first embodiment.

### Third Embodiment

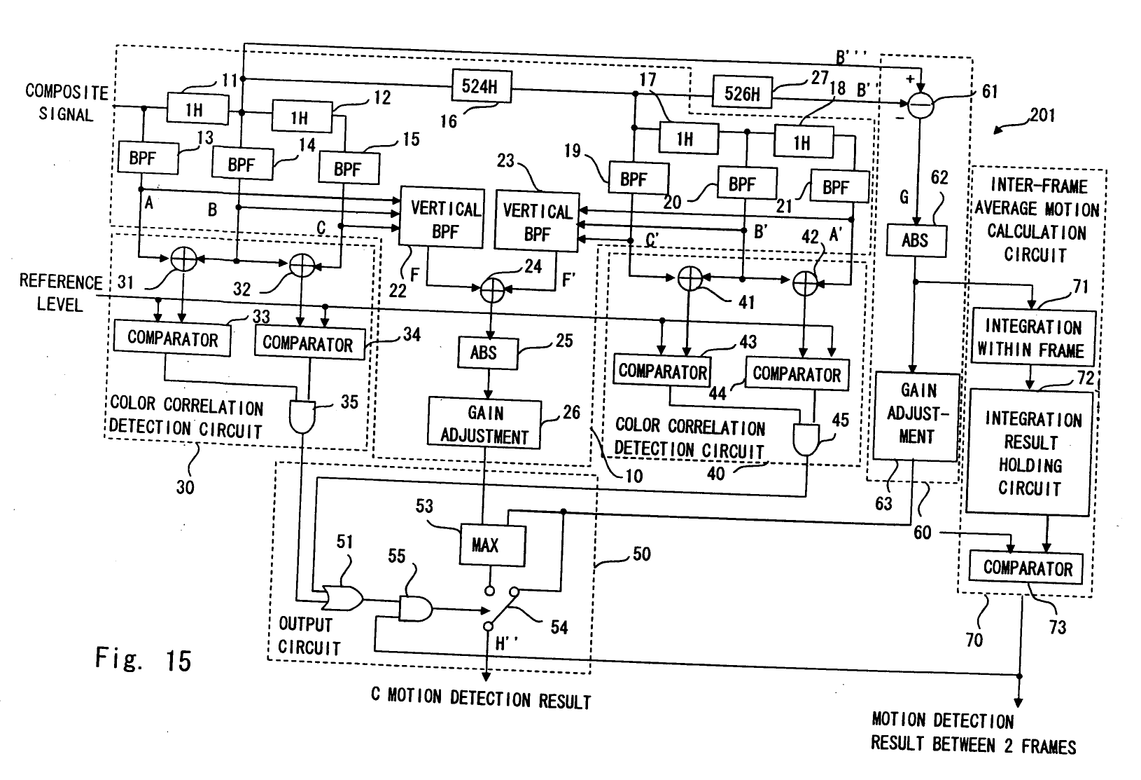

Next, the third embodiment of the present invention is explained. FIG. 15 is a block diagram showing a color motion detection circuit according to this embodiment. Note that components identical to those in the first embodiment shown in FIG. 1 are denoted by reference numerals identical to those therein with detailed description omitted. In addition to the color motion detection circuit according to the second embodiment, an inter-frame average calculation circuit 70 is included which performs an integration to each pixel for a motion inside frame, holds the result for 1 frame period, compares the result with the reference level in order to detect motions in the entire frame and outputs the determination result. This prohibits 1 frame color motion detection if the entire frame is determined as still.

That is, the inter-frame average motion calculation circuit 70 includes an inter-frame integration circuit 71 for performing an integration process to all sampling points inside frame for output values of the absolute value conversion circuit 62 in the motion detection circuit between 2 frames so as to calculate motion result of the entire frame, an integration result holding circuit 72 for holding the output result of the inter-frame integration circuit of the previous frame for 1 frame period and a comparator 73 for comparing the output of the integration result holding circuit 72 with a reference level 2, which determines the entire frame as motion.

Moreover, the output circuit 50 includes an AND circuit 55 and a switch 54 for validating the result of the 1 frame color motion detection circuit only when either of the color correlation detection results of the current frame or the previous frame is determined as “line correlation exists” and also the inter-frame average motion detection circuit is determined as “motion exists” and in other cases, validating the output result of the motion detection circuit between 2 frames. As with the second embodiment, when using the result of the 1 frame color motion detection circuit 10, the maximum value is taken between the motion detection circuit between 2 frames 60 and the maximum value is output as a last color motion detection result.

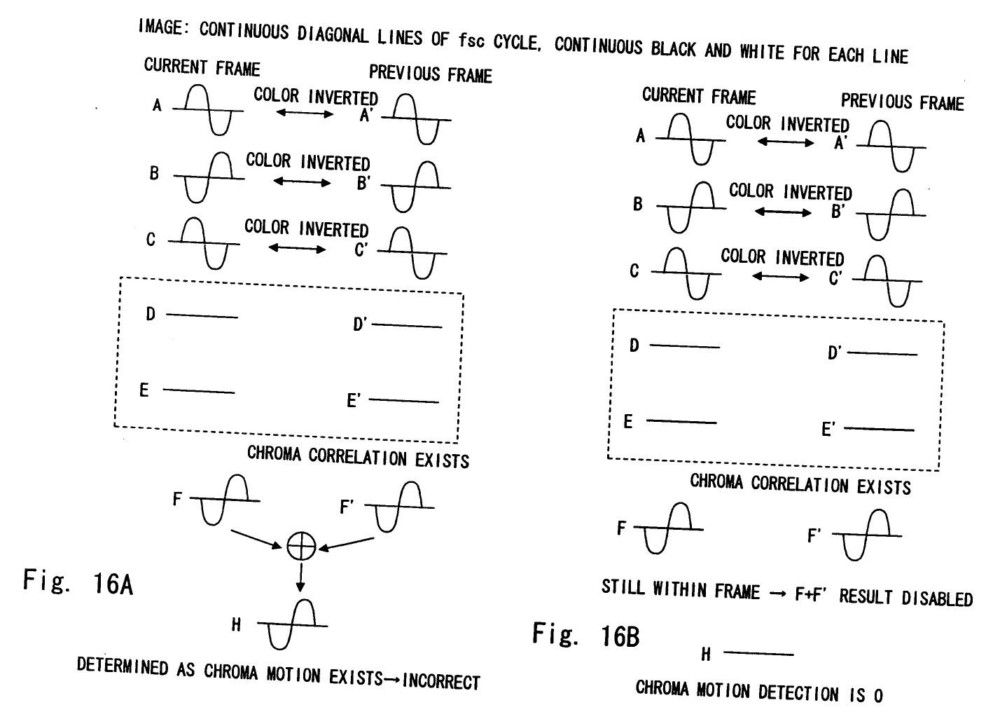

Next, the effect obtained in this embodiment is explained. FIGS. 16A and 16B explain the effect according to this embodiment. FIG. 16A shows an image of a pattern which is incorrectly detected in the second embodiment shown in FIG. 12. In case of continuous diagonal lines of chrominance subcarrier frequency fsc cycle and continuous black and white for each line, as shown in FIG. 16A, it is incorrectly determined as “line correlation exists”. Thus the value F of the vertical BPFs 22 and 23 is added and H is output as a motion detection result. That is, in the first and the second embodiments, it will be output as motion exists. On the other hand, in this embodiment, since the inter-frame average motion calculation circuit 70 detects a motion inside frame, it can be determined as no motion. Furthermore, as a result of F+F′, meaning that the 1 frame color motion detection result is disabled, the C motion detection result is determined as no motion and it is correctly determined.

In this embodiment, the 1 frame color motion detection result and the motion detection result between 2 frames are switched according to the result of the color correlation detection circuit. Furthermore, a motion in a frame is detected and if there is no motion in the frame, the 1 frame color motion detection result is disabled. This further suppresses incorrect detection and enables to obtain highly accurate C motion detection result.

Note that the present invention is not limited to the above embodiments, but various modification can be made without departing from the scope and spirit of the invention. For example, it is needless to say that the Y/C separation circuit of the first embodiment shown in FIG. 2 and the Y/C separation circuit of the second embodiment shown in FIG. 13 can be incorporated to the third embodiment.

It is apparent that the present invention is not limited to the above embodiments, but may be modified and changed without departing from the scope and spirit of the invention.

What is claimed is:

1. A color motion detection circuit comprising:
a color correlation detection circuit to detect a correlation of chrominance signals in a plurality of lines and detect whether there is a color correlation between the lines;
a 1 frame color motion detection circuit to perform a vertical band pass filter process to chrominance signals of a plurality of consecutive lines for each signal in a current frame and a previous frame and perform a 1 frame color motion detection according to the vertical band pass filter process result; and
an output circuit to output a color motion detection result according to a detection result of the 1 frame color motion detection circuit in case the color correlation detection circuit determines as a line correlation exists.

2. The color motion detection circuit according to claim 1, further comprising:
a motion detection circuit between 2 frames to detect a motion between 2 frames,
wherein the output circuit outputs an output of the motion detection circuit between 2 frames as the color motion detection result in case the color correlation detection circuit determines as no correlation.

3. The color motion detection circuit according to claim 2, wherein the output circuit outputs a maximum value of the output of the 1 frame color motion detection circuit and the output of the motion detection circuit between 2 frames as the color motion detection circuit in case the color correlation detection circuit determines as the line correlation exists.

4. The color motion detection circuit according to claim 2, further comprising an inter-frame average motion calculation circuit to detect a motion for an entire frame by integrating for each pixel in the frame and comparing the integration result with a standard level,
wherein the output circuit disables the output of the 1 frame color motion detection circuit in case the inter-frame average motion detection circuit determines the entire frame is still.

5. The color motion detection circuit according to claim 3, further comprising an inter-frame average motion calculation circuit to detect a motion for an entire frame by integrating for each pixel in the frame and comparing the integration result with a standard level,
wherein the output circuit disables the output of the 1 frame color motion detection circuit in case the inter-frame average motion detection circuit determines the entire frame is still.

6. The color motion detection circuit according to claim 1, wherein the color correlation detection circuit detects a correlation of chrominance signals in a target line and a previous line and a correlation of chrominance signals in the target line and a next line and detects as the line correlation exists in case a line correlation exists in both adjacent lines of the target line.

7. The color motion detection circuit according to claim 2, wherein the color correlation detection circuit detects a correlation of chrominance signals in a target line and a previous line and a correlation of chrominance signals in the target line and a next line and detects as the line correlation exists in case a line correlation exists in both adjacent lines of the target line.

8. The color motion detection circuit according to claim 3, wherein the color correlation detection circuit detects a correlation of chrominance signals in a target line and a previous line and a correlation of chrominance signals in the target line and a next line and detects as the line correlation exists in case a line correlation exists in both adjacent lines of the target line.

9. The color motion detection circuit according to claim 1, wherein the 1 frame motion detection circuit performs a horizontal band pass filter process to each composite signal of consecutive 3 lines and extracts a chrominance signal.

10. The color motion detection circuit according to claim 2, wherein the 1 frame motion detection circuit performs a horizontal band pass filter process to each composite signal of consecutive 3 lines and extracts a chrominance signal.

11. The color motion detection circuit according to claim 3, wherein the 1 frame motion detection circuit performs a horizontal band pass filter process to each composite signal of consecutive 3 lines and extracts a chrominance signal.

12. The color motion detection circuit according to claim 1, wherein the 1 frame motion detection circuit performs a vertical band pass filter process to chrominance signals of consecutive 3 lines and performs an addition process between frames.

13. The color motion detection circuit according to claim 2, wherein the 1 frame motion detection circuit performs a vertical band pass filter process to chrominance signals of consecutive 3 lines and performs an addition process between frames.

14. The color motion detection circuit according to claim 3, wherein the 1 frame motion detection circuit performs a vertical band pass filter process to chrominance signals of consecutive 3 lines and performs an addition process between frames.

15. The color motion detection circuit according to claim 2, wherein the motion detection circuit between 2 frames detects a motion between the 2 frames by a difference in a composite signal.

16. The color motion detection circuit according to claim 3, wherein the motion detection circuit between 2 frames detects a motion between the 2 frames by a difference in a composite signal.

17. A Y/C separation circuit comprising:
a color motion detection circuit to output a color motion detection result;
a coefficient mix circuit to generate a chrominance signal by mixing a chrominance signal within frame and a chrominance signal between frames according to a luminance motion detection result and the color motion detection result, the chrominance signal within frame being a chrominance signal extracted using signals in a same frame and the chrominance signal between frames being a chrominance signal extracted using signals between adjacent frames; and
a subtractor to subtract the chrominance signal from a composite signal and output a luminance signal,
wherein the color motion detection circuit includes;
a color correlation detection circuit to detect a correlation of chrominance signals in a plurality of lines and detect whether there is a color correlation between the lines;
a 1 frame color motion detection circuit to perform a vertical band pass filter process to chrominance signals of a plurality of consecutive lines for each signal in a current frame and a previous frame and perform a 1 frame color motion detection according to the vertical band pass filter process result; and
an output circuit to output a color motion detection result according to a detection result of the 1 frame color motion detection circuit in case the color correlation detection circuit determines as a line correlation exists.

18. The Y/C separation circuit according to claim 17, further comprising a mix circuit to output a maximum value among the luminance motion detection result and the color motion detection result.

19. A Y/C separation circuit comprising:
a first coefficient mix circuit to generate a chrominance signal by mixing a chrominance signal within frame and a chrominance signal between frames according to a luminance motion detection result and a motion detection result between 2 frames, the chrominance signal within frame being a chrominance signal extracted using signals in a same frame and the chrominance signal between frames being a chrominance signal extracted using signals between adjacent frames;
a subtractor to subtract a chrominance signal generated by the first coefficient mix circuit from a composite signal and output a luminance signal;
a color motion detection circuit to output a color motion detection result; and
a second coefficient mix circuit to mix the chrominance signal within frame and the chrominance signal between frames according to the color motion detection result and generate a chrominance signal,
wherein the color motion detection circuit includes:
a color correlation detection circuit to detect a correlation of chrominance signals in a plurality of lines and detect whether there is a color correlation between the lines;
a 1 frame color motion detection circuit to perform a vertical band pass filter process to chrominance signals of a plurality of consecutive lines for each signal in a current frame and a previous frame and perform a 1 frame color motion detection according to the vertical band pass filter process result; and
an output circuit to output a color motion detection result according to a detection result of the 1 frame color motion detection circuit in case the color correlation detection circuit determines as a line correlation exists.

20. The Y/C separation circuit according to claim 19, further comprising a mix circuit to output a maximum value among the luminance motion detection result and the motion detection result between 2 frames.
